(19) United States
(12) Patent Application Publication
(10) Pub. No.: US 2019/0325491 A1
(43) Pub. Date: Oct. 24, 2019

(54) SYSTEMS AND METHODS FOR PROVIDING A CUSTOMER DISINCENTIVE

(71) Applicant: CAPITAL ONE SERVICES, LLC, Mclean, VA (US)

(72) Inventor: JIE ZHANG, Arlington, VA (US)

(73) Assignee: CAPITAL ONE SERVICES, LLC, Mclean, VA (US)

(21) Appl. No.: 15/958,176

(22) Filed: Apr. 20, 2018

(51) Int. Cl. G06Q 30/02; G06Q 40/02; G06Q 20/42; G06F 17/30

(52) U.S. Cl. CPC G06Q 30/0283; G06F 17/30241; G06Q 20/42; G06Q 40/02

(57) ABSTRACT

Systems and methods for providing customer spending disincentive, wherein the system includes one or more memory devices storing software instructions and one or more processors configured to execute the software instructions to receive customer data and customer location data from a customer device, identify a customer and a merchant based on the received data, determine an applicable customer disincentive option based on customer preference data included in the received customer data, the customer disincentive relating to a potential retail transaction with the identified merchant, and transmit a notification to the customer device, the notification including the determined customer disincentive option.

### TECHNICAL FIELD

The disclosed embodiments generally relate to systems and methods for providing a customer disincentive, and more particularly, systems and methods for processing customer disincentives associated with a financial account.

### BACKGROUND

Some retail customers of goods and/or services may have shopping problems. For example, some customers may be addicted to shopping or spend too much money per month on coffee, and customers having shopping problems may want help spending less or may have trouble keeping track of their spending. For customers struggling with spending a need exists to help reduce or prevent unwanted spending and/or to help adhering to a budget.

### SUMMARY

The disclosed embodiments describe systems and methods for providing customer spending disincentives, such as preemptively prohibiting spending at particular types of merchants or a specific merchant identified by a customer.

In one embodiment, a system for providing a customer disincentive includes one or more memory devices storing software instructions, and one or more processors configured to execute software instructions to: receive customer and location data from a device associated with a customer of the financial service provider, identify the customer based on the customer data, identify a merchant and merchant premises at or near the customer location based on the received location data, determine an applicable customer disincentive option based on customer preference data included in the received customer data, the disincentive relating to a potential retail transaction for goods or services with the identified merchant, and transmit a notification to the customer device, the notification including the determined customer disincentive option.

In another embodiment, a method for a financial service provider to provide a customer disincentive includes determining, by one or more processors, an applicable customer disincentive for a customer of the financial service provider, receiving customer data and location data from the customer device, transmitting a notification to a device associated with a customer of the financial service provider, the notification including the applicable customer disincentive, the notification being transmitted when the customer is at or near a merchant premises, and determining an instruction based on customer preference data included in the received customer data relating to the applicable customer disincentive associated with a financial account of the customer.

It is to be understood that both the foregoing general description and the following detailed description are exemplary and explanatory only and are not restrictive of the disclosed embodiments, as claimed.

### BRIEF DESCRIPTION OF THE DRAWING

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with the disclosed embodiments;

FIG. 2A is a block diagram of an exemplary server, consistent with disclosed embodiments;

FIG. 2B is a block diagram of an exemplary customer device, consistent with disclosed embodiments;

FIG. 3 is a flow chart of an exemplary process for providing a customer disincentive, consistent with disclosed embodiments;

FIG. 4 is a flowchart of an exemplary process for communicating with a customer device to provide information related to a customer disincentive, consistent with the disclosed embodiments; and

FIG. 5 depicts exemplary customer device user interface displays of information related to customer disincentives, consistent with disclosed embodiments.

### DETAILED DESCRIPTION

Reference will now be made in detail to the disclosed embodiments, examples of which are illustrated in the accompanying figures. The disclosed systems and methods relate to providing a customer spending disincentive.

In one embodiment, the disclosed systems and methods allow customers to control their spending habits by choosing when to selectively freeze a financial account, in order to restrain unwanted spending.

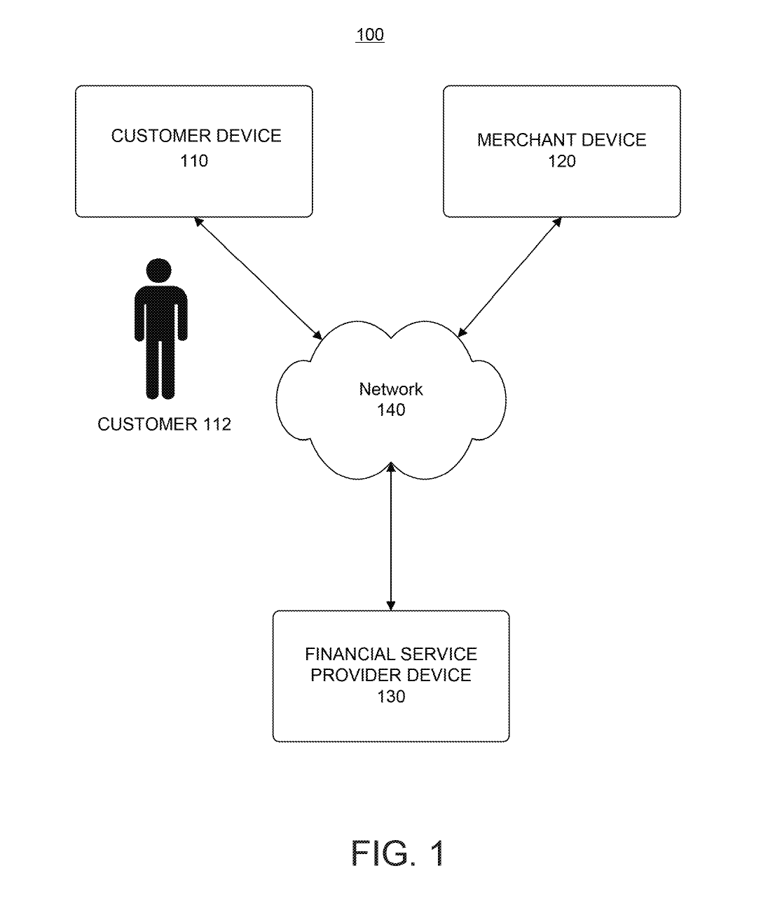

FIG. 1 is a block diagram illustrating an exemplary system 100, consistent with disclosed embodiments that may be configured for performing a customer disincentive process consistent with disclosed embodiments. As shown, system 100 includes a customer device 110, a merchant device 120, and a financial service provider device 130, all of which are communicatively coupled by a network 140. While only one customer device 110, merchant device 120, and financial service provider device 130 are shown, it will be understood that system 100 may include more than one customer device 110, merchant device 120, and/or financial service provider device 130. The components and arrangement of the components included in system 100 may vary.

Each of devices 110-130 may be a computing system configured to provide, use, and/or process customer data and location data. As further described herein, devices 110-130 may include one or more computing devices (e.g., computer(s), server(s), embedded systems), memory storing data and/or software instructions (e.g., database(s), memory devices. In some embodiments, the one or more computing devices are configured to execute software instructions stored on one or more memory devices to perform one or more operations consistent with the disclosed embodiments. Each of devices 110-130 may be configured to communicate with one or more of devices 110-130. In certain aspects, users may operate one or more of devices 110-130 to initiate one or more operations consistent with the disclosed embodiments. For example, customer device 110 may be operated by a customer 112. Customer 112 may be an owner/operator of customer device 110, such as a customer of one or more entities associated with devices 120 and 130. In other aspects, users may be employees of, or associated with, the entity corresponding to devices 120 and/or 130 (e.g., someone authorized to use the underlying computing systems or otherwise act on behalf of the entity). In other aspects, the one or more users may not be an employee or otherwise associated with the underlying entity. In some aspects, the one or more users may be an entity, rather than individual(s), associated with the respective device 120 or 130.

Customer device 110 may be one or more computing devices configured to execute software instructions for performing one or more operations consistent with the disclosed embodiments. In one embodiment, customer device 110 may be a mobile device (e.g. tablet, smartphone, etc.), a desktop computer, a laptop, a server, a wearable device (eyeglasses, a watch, etc.), and/or device dedicated hardware device. Customer device 110 may include one or more processors configured to execute software instructions stored in memory, such as memory included in customer device 110. Customer device 110 may include software that, when executed by a processor, performs known Internet-related communication and content display processes. For instance, customer device 110 may execute browser software that generates and displays interface screens including content on a display device included in, or connected to, customer device 110. The disclosed embodiments are not limited to any particular configuration of customer device 110. For instance, customer device 110 may be a mobile device that stores and executes mobile applications that provide financial-service-related functions offered by a financial service provider, such as an application associated with one or more financial accounts that a customer (e.g., customer 112) holds with a financial service provider. Customer 112 may enter and store customer preferences pertaining to applicable disincentives on customer device 110. For example, customer 112 may select categories of merchants or a specific merchant associated with the disincentive. Additionally, the disincentive may be an alert in a transmitted notification sent to customer device 110 from financial service provider device 130 and/or merchant device 120. The alert may notify customer 112 that they are approaching a merchant from a category of merchants or specific merchant previously selected by customer 112. For example, the alert may be sent when customer 112 is within a predetermined distance from the merchant. The distance could, for example, be a quarter mile or less, or alternatively, a much shorter distance such as one city block or less or two city blocks or less. For example, the alert may notify customer 112 that they are within one city block of a specific merchant previously selected by customer 112.

Additionally, customer 112 may enter and store customer preferences pertaining to applicable disincentives on customer device 110. The preferences may include freezing a financial account of the customer when they are within a certain distance of a specific merchant or when they are on the specific merchant premises. The preferences may also include a spending threshold associated with a specific merchant. For example, the preferences may include an alert notifying customer 112 how much money they have spent relative to the spending threshold. The preferences may further specify that the financial account associated with customer 112 may be frozen if customer 112 exceeds the spending threshold.

In one embodiment, customer 112 uses customer device 110 to perform one or more operations consistent with the disclosed embodiments. In one aspect, customer 112 may be a customer or potential customer of a merchant associated with merchant device 120. For instance, customer 112 may transact business with the merchant associated with merchant device 120. In another aspect, customer 112 may be a customer of a financial service provider associated with financial service provider device 130. For instance, the financial service provider may maintain a financial service account (e.g., checking account, credit account, or the like) for customer 112.

Merchant device 120 is associated with a merchant, such as a provider of goods and/or services, such as a retailer or restaurant. Merchant device 120 may include one or more computing systems that are configured to perform computer-implemented processes, such as a server, desktop, laptop, mobile device, embedded system or other dedicated hardware. Further, merchant device 120 may include one or more computing devices configured to process and handle purchase transactions at a physical location of the associated merchant, such as point of sale terminals, local servers, kiosks, barcode scanners, etc. at a retail location. Merchant device 120 may be configured to perform financial transaction processes, such as receiving, processing, and handling purchase transactions, payment processes, etc., associated with the sale of goods and/or services provided by the associated merchant. In some aspects, merchant device 120 may include computing devices that include back and/or front-end computing components that store consumer transaction data and execute software instructions to perform operations consistent with the disclosed embodiments, such as computers that are operated by employees of the associated merchant (e.g., back-office systems).

Financial service provider device 130 may be associated with a financial service provider. The financial service provider may be a bank, credit union, credit card issuer, or other type of financial service entity that generates, provides, manages, and/or maintains financial service accounts for one or more users (e.g., customer 112). Financial service accounts may include, for example, checking accounts, and any other types of financial service accounts known to those skilled in the art. Financial service accounts may be associated with electronic accounts, such as a digital wallet or similar account that may be used to perform electronic transactions, such as purchasing goods and/or services online. Financial service accounts may also be associated with physical financial service account cards, such as a debit or credit card that customer 112 may carry on their person and use to perform financial service transactions, such as purchasing goods and/or services at a point of sale terminal (e.g., merchant device 120).

The financial service provider includes infrastructure and components that are configured to generate and provide financial service accounts and financial service account cards (e.g., debit cards, credit cards). The financial service provider may also include infrastructure and components that are configured to manage transactions associated with a customer service account. In certain aspects, financial service provider device 130 may include one or more computing devices configured to communicate with customer device 110 and merchant device 120 via network 140 to execute processing steps associated with providing a customer disincentive.

In certain aspects, the financial service provider associated with financial service provider device 130 may provide a primary financial service to a customer, e.g., customer 112. For example, the financial service provider may maintain a credit card account with customer 112, in a manner known in the art. In addition to the primary service (e.g., credit card account), the financial service provider may also provide additional services to customer 112 to implement a customer 112 actuatable “customer disincentive.” These additional services may include, for example, temporarily freezing a credit line associated with customer 112, consistent with the customer's instructions. The credit line may be frozen while customer 112 remains in a merchant's premises. Consistent with disclosed embodiments, components of system 100 may cooperate over network 140 to provide a customer disincentive to customer 112.

Network 140 may be any type of network configured to provide communications between components of system 100. For example, network 140 may be any type of network (including infrastructure) that provides communications, exchanges information, and/or facilitates the exchange of information, such as the Internet, a Local Area Network, near field communication (NFC), or other suitable connection(s) that enables the sending and receiving of information between the components of system 100. In other embodiments, one or more components of system 100 may communicate directly through a dedicated communication link(s) (not shown), such as a link between customer device 110 and merchant device 120.

In some embodiments, customer 112 associated with customer device 110 may purchase goods and/or services from the merchant associated with merchant device 120. In some instances, customer 112 may use a financial account provided by a financial service provider such as the financial service provider associated with device 130 to pay for the goods and or/services. In other instances, customer 112 may use another payment method, such as cash.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations of those described herein) will be apparent to persons skilled in the relevant art(s) based on the teachings contained herein. For example, merchant device 120 may include financial service provider device 130 for performing operations associated with a private label financial account provided by a merchant associated with merchant device 120. Such alternatives fall within the scope and spirit of the disclosed embodiments.

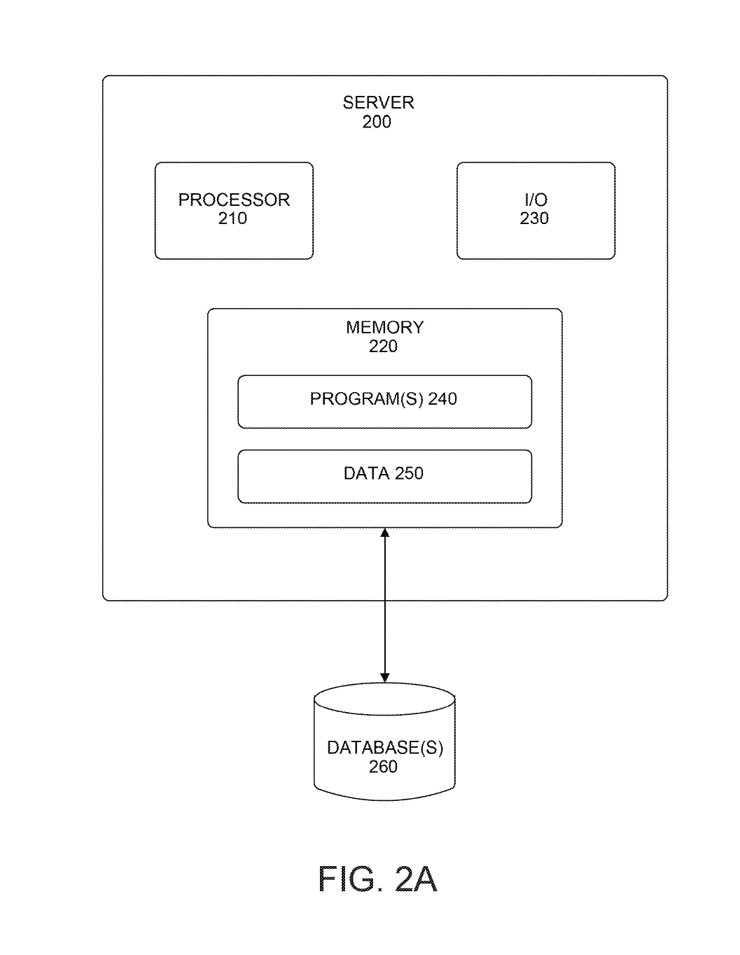

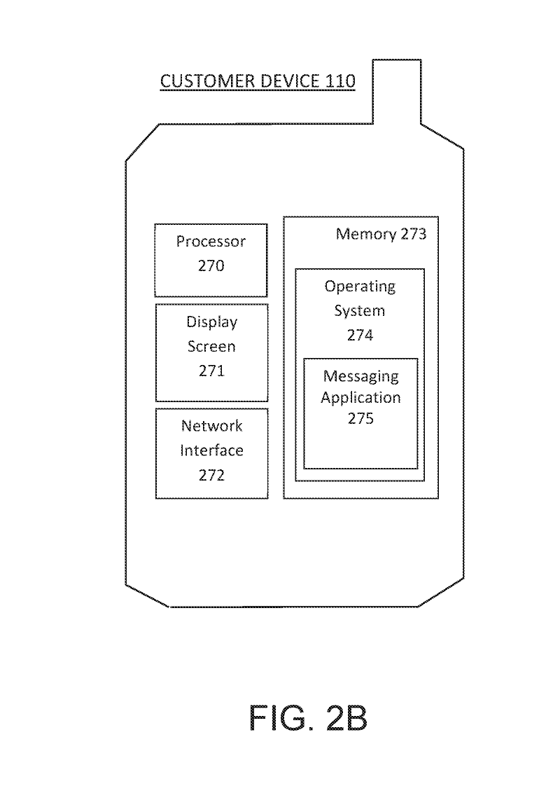

FIG. 2A shows an exemplary block diagram of a server 200 for implementing embodiments consistent with the present disclosure. Variations of server 200 may be used by merchant device 120, and/or financial service provider device 130.

In one embodiment, server 200 includes one or more processors 210, one or more memories 220, and one or more input/output (I/O) devices 230. According to some embodiments, server 200 may be an embedded system or similar computing device that generates, maintains, and provides web site(s) consistent with disclosed embodiments. Server 200 may be standalone, or it may be part of a subsystem, which may be part of a larger system. For example, server 200 may represent distributed servers that are remotely located and communicate over a network (e.g., network 140) or a dedicated network, such as a LAN. Server 200 may correspond to any of merchant device 120 and financial service provider device 130.

Processor 220 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. The disclosed embodiments are not limited to any type of processor(s) otherwise configured to meet the computing demands required of different components of server 200.

Memory 220 may include one or more storage devices configured to store instructions used by processor 210 to perform functions related to disclosed embodiments. For example, memory 220 may be configured with one or more software instructions, such as program(s) 240 that may perform one or more operations when executed by processor 210. The disclosed embodiments are not limited to separate programs or computers configured to perform dedicated tasks. For example, memory 220 may include a single program 240 that embodies the functions of server 200, or program 240 could comprise multiple programs. Additionally, processor 210 may execute one or more programs located remotely from server 200. For example, customer device 110, merchant device 120, and/or financial device 130, may, via server 200, access one or more remote programs that, when executed, perform functions related to certain disclosed embodiments. Memory 220 may also store data 250 that reflects any type of information in any format that server 200 may use in system 100 to perform operations consistent with the disclosed embodiments.

I/O device 230 may be one or more devices configured to allow data to be received and/or transmitted by server 200. I/O devices 230 may include one or more digital and/or analog communication devices that allow server 200 to communicate with other machines and devices, such as other components of system 100.

Server 200 may also be communicatively connected to one or more database(s) 260. Server 200 may be communicatively connected to database(s) 260 through network 140. Database 260 may include one or more memory devices that store information and are accessed and/or managed through server 200. By way of example, database(s) 260 by include Oracle™ databases, Sybase™ database, or other relational databases or non-relational databases, such as Hadoop sequences files, HBase, or Cassandra. The databases or other files may include, for example, data and information related to the source and destination of a network request, the data contained in the request, etc. Systems and methods of the disclosed embodiments, however, are not limited to separate databases. In one aspect, system 200 may include database 260. Alternatively, database 260 may be located remotely from server 200. Database 260 may include computing components (e.g., database management system, database server, etc.) configured to receive and process requests for data stored in memory devices of database(s) 260 and to provide data from database 260.

FIG. 2B shows an exemplary block diagram of customer device 110 for implementing embodiments consistent with the present disclosure. Customer device 110 may be a mobile device with computing capabilities, such as a tablet, a smartphone, or any combination of these devices and/or affiliated components. As shown, customer device 110 includes one or more processors 270, a display screen 271, a network interface 272, and one or more memory devices 273 storing one or more operating systems 274, including an inbuilt messaging application 275.

Display screen 271 may include, for example, a liquid crystal display (LCD), a light emitting diode screen (LED), an organic light emitting diode screens (OLED), a touch screen, or other known display screens. Display screen 271 may display various kinds of information consistent with disclosed embodiments.

Network interface 272 allows customer device 110 to send and receive information through network 140. Alternatively, or in addition, network interface 272, may establish direct wired or wireless connection between customer device 110 and other system components, such as server 200.

Memory 273 may be, for example, a magnetic, semiconductor, tape, optical, removable, non-removable, or other type of storage device or tangible (e.g., non-transitory) computer-readable medium. Memory 273 may store operating system 274, as well as data and mobile applications for performing operations consistent with functions described below.

Operating system 274 may perform known operating system functions when executed by processor 270. By way of example, the operating system may include Android™, Apple OS X™, Unix™, Linux™, or others. Accordingly, examples of the disclosed invention may operate and function with computer systems running any type of operating system having an inbuilt messaging application. Messaging application 275, when executed by processor 270, provides text messaging communication via network 140.

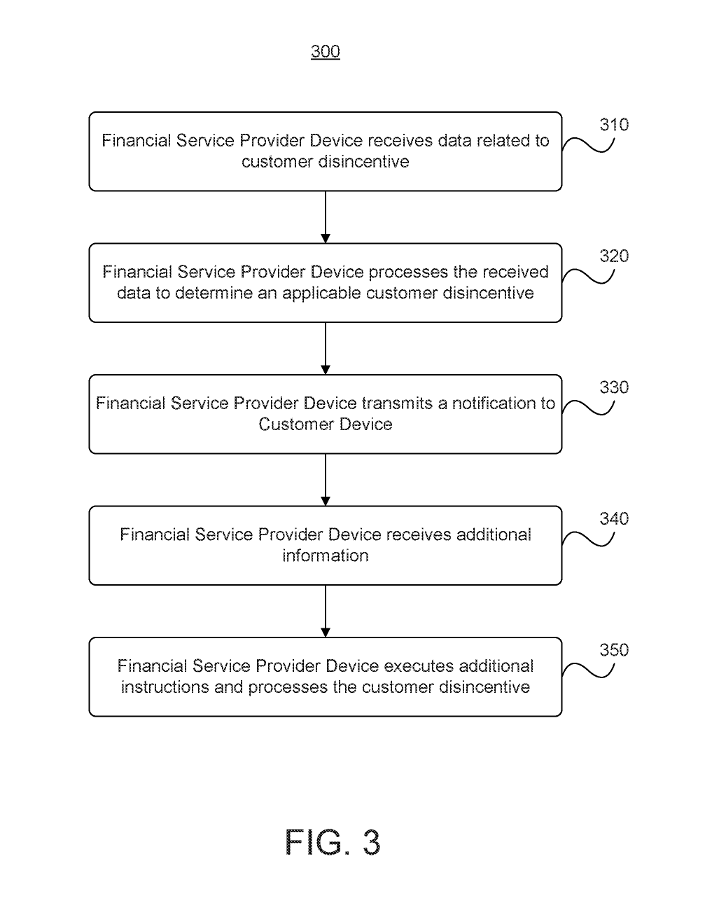

FIG. 3 is a flowchart of an exemplary process 300 performed by financial service provider device 130 for providing a customer disincentive consistent with embodiments of the present disclosure. In some aspects, the customer disincentive may be turning off a customer's credit line temporarily while the customer is near or inside a merchant's premises. In other aspects, the disincentive may be transmitting a notification to a customer device with an alert consistent with the disclosed embodiments. It should be understood, however, that the disclosed embodiments are not limited to these types of customer disincentive options, nor are they limited to being provided by a financial service provider. The exemplary disclosed embodiments may be applicable to any service provided to a customer. In describing exemplary process 300, the customer is assumed to be customer 112 associated with customer device 110.

Process 300 includes financial service provider device 130 receiving data from customer device 110 and/or merchant device 120 related to a customer transaction or customer disincentive options (step 310). In some aspects, the data may be related to a transaction or potential transaction with merchant device 120. The received data may include information related to a potential transaction (pre-transaction data) and/or information related to a transaction that has already taken place (post-transaction data). Pre-transaction data may include a location of customer device 110, which may be associated with the location of customer 112 and a merchant or merchant's premises (e.g., a specific merchant previously selected by customer 112), and/or information related to an item or service that is the subject of the potential transaction. Pre-transaction data may also include customer data received from customer device 110. Post-transaction data may include information about a transaction that previously occurred, which may be received from customer device 110 and/or merchant device 120. For example, post-transaction data may include information from merchant device 120 regarding the purchase of a product by customer 112 with a credit card maintained by the financial service provider associated with financial service provider device 130. Pre and post-transaction data may also include a transaction history of customer 112 with the merchant associated with merchant device 120 and also customer preference data. The applicable customer disincentive option is based on customer preference data included in the customer data received by financial service provider device 130 from customer device 110, the disincentive relating to a potential retail transaction for goods or services.

Location data may be determined by customer device 110. For example, customer device 110 may include a GPS device that provides geographic location information (not shown). In some embodiments, the GPS device may communicate with a GPS satellite navigation system that is used to determine the precise location of customer device 110. The GPS device may decode time signal transmissions received from multiple satellites to determine the position of customer device 110 using, for example, trilateration techniques performed by a processor executing software stored on a memory device within the GPS device. Customer device 110, therefore, may calculate and transmit geographic position information (e.g., location coordinates or the like) associated with customer device 110 to financial service provider device 130.

Additionally or alternatively, location data may be determined by customer device 110 through the Foursquare™ application. The Foursquare™ application is primarily for letting friends know where you are and figuring out where they are, as known in the art.

The data received from customer device 110 and/or merchant device 120 by financial service provider device 130 may also include customer data that allows financial service provider device 130 to determine the identity of customer 112 associated with customer device 110. For example, the customer data may include login information associated with a financial services application on a mobile device. The customer data may identify the customer's name, contact information, account information, etc. Additionally, the customer data may include a merchant specific purchase transaction history over a period of time. The customer data may also include the disincentive options.

Process 300 also includes financial service provider device 130 processing the received data related to the customer transaction or potential transaction and location data to determine an applicable customer disincentive, which includes determining whether a disincentive is applicable (step 320). For example, financial service provider 130 may execute software instructions to determine if the received data corresponds to any customer disincentive options applicable to customer 112. In some embodiments, no customer disincentive options correspond to the received data.

In some aspects, financial service provider 130 may process the received data to determine the identity of customer 112 and financial account (e.g., credit card account) associated with the customer data. For example, financial service provider device 130 may receive pre-transaction data from customer device 110 indicating that customer 112 is located near or is approaching (e.g., within a block, two blocks) a specific merchant or category of merchants previously selected by customer 112 or inside the specific merchant's premises. In some embodiments, financial service provider device 130 may execute software instructions to search an electronic database to retrieve information that matches the received data, which may include customer-identifying information, customer preference data, financial account information, etc.

Based on the retrieved information that matches the received data, financial service provider device 130 may determine that a customer disincentive option is available to customer 112. In some embodiments, financial service provider device 130 may execute software instructions to identify one or more customer disincentive options that are associated with a financial account held by customer 112 and match the information received in step 310. For example, financial service provider device 130 may determine that the received data indicates a potential purchase and may also determine that customer 112 who may make the purchase meets one or more criteria for a customer disincentive option associated with the specific merchant where the potential transaction could transpire. For example, financial service provider device 130 may determine that the identified customer is at or near a specific merchant in the received customer preference data from customer device 110 and the corresponding disincentive is to transmit a notification to customer device 112. The notification is determined from customer preference data and may include a spending history of customer 112 with the specific merchant. For example, the notification may include customer 112's purchases with the specified merchant within the last week, month, or year. Alternatively, the notification may show customer 112 their average purchase value associated with the specific merchant. Customer device 110 obtains purchase information from data of the account maintained by financial service provider for customer 112. As used herein, the customer location is near a merchant or merchant premises when the customer is directly outside, one block or less, or two blocks or less from the merchant premises. Further, the customer location is at the merchant or merchant premises when the customer is within the merchant premises.

If financial service provider device 130 determines that a customer disincentive is applicable, financial service provider device 130 transmits a notification to customer device 110 (step 330). In some aspects, the notification alerts the customer that the customer disincentive is applicable. For example, in an embodiment in which the customer disincentive determined in step 320 is a temporary credit line freeze (e.g., 5, 10, 15, 20, 25, 30 minutes, or any amount of time), financial service provider device 130 may send a notification to customer device 110, which may be a mobile device, to alert customer 112 of pending implementation of a customer disincentive option. The alert may be transmitted, for example, as an sms text message, a push notification, in-app notification, email, in substantially real time (i.e., before customer 112 has made a purchase from the merchant). The alert may notify customer 112 of their proximity to a merchant specified by the customer data (e.g., within a block). The alert may further notify customer 112 that the disincentive will commence for a period of time if customer 112 enters the merchant's premise.

In other aspects, the notification may inform customer 112 of the option to override the customer disincentive. For example, in an embodiment in which the disincentive determined in step 320 is a temporary credit line freeze, financial service provider device 130 may send a notification to customer device 110 that includes an option to dismiss the customer disincentive option.

The notification may also include information about the customer's transaction history with the identified merchant. For example, if customer 112 approaches a specific merchant, the notification may include the customer's spending history with the specific merchant for the prior days, weeks, months, years, allowing customer 112 to assess their purchases over time.

Similarly, the information about the customer's transaction history may include a potential cost and/or cost savings to customer 112. In some embodiments, financial service provider device 130 may execute software instructions to calculate cost savings available to customer 112 by exercising the customer disincentive option.

As described above, the information sent to customer device 110 as part of the notification transmitted in step 330 may be displayed to customer 112 such as via a display device connected to or part of customer device 110. For example, customer device 110 may be a mobile device (e.g., smart phone, tablet) that receives the notification transmitted from financial service provider device 130 and displays the notification to customer 112. For example, if the notification is a text message, customer device 110 may execute software instructions to process the received notification and display it to customer 112 as a received text message in a manner known in the art.

It should be understood that the information transmitted to customer device 110 from financial service provider device 130 may be processed by customer device 110 through a software program, such as a mobile application. Customer device 110 may execute software instructions to run the mobile application and present the information to customer 112 in any manner. For example, customer device 110 may store the information from financial service provider device 130 in an electronic database, and only display information when requested by customer 112. Interactive menus and/or other selection tools may be provided by or via customer device 110 to allow customer 112 to decide what information is displayed, stored, transmitted.

In some embodiments, customer 112 may interact with customer device 110 to provide additional information regarding the available customer disincentive. For example, customer device 110 may receive input through an I/O device (e.g., touch screen, keypad) and store the input as data associated with the available customer disincentive transmitted to customer device 110 in step 330. The additional information may include information requested as part of the notification sent from financial service provider device 130. For example, the notification sent from financial service provider device 130 may include a prompt for additional information, such as the type of merchant or the name of a merchant at which a transaction may take place. In other aspects, the additional information may include an indication of acceptance or refusal of the customer disincentive. For example, customer 112 may input to customer device 110 an acceptance of the customer disincentive. The additional information may be transmitted by customer device 110 to financial service provider device 130. In some aspects, additional information may be transmitted by merchant device 120. For example, merchant device 120 may provide transaction information pertinent to a customer disincentive option.

Process 300 further includes financial service provider device 130 receiving the additional information transmitted by customer device 110 and/or merchant device 120 (step 340). In some aspects, financial service provider device 130 may process the received additional information to further process and determine an applicable customer disincentive. For example, financial service provider device 130 may execute software instructions to determine how the additional information affects a customer's eligibility for a customer disincentive or how the additional information affects the customer disincentive that is applicable to customer 112. In other words, the additional information may allow financial service device 130 to complete a determination of which customer disincentive applies to customer 112 at that time. In these embodiments, steps 320-340 may be repeated to allow customer device 110, merchant device 120, and financial service provider device 130 to communicate with each other through as many iterations as necessary to allow the financial service provider to provide, and customer 112 to receive, the customer disincentive.

In other aspects, financial service provider device 130 may receive the additional information from customer device 110 as an indication that a customer disincentive has been accepted or declined by customer 112. If the customer disincentive option has been accepted (e.g., not overridden), financial service provider device 130 may execute additional software instructions associated with the accepted customer disincentive with the customer's financial account. Financial service provider device 130 may execute additional processing, as necessary. For example, financial service provider device 130 may send an additional notification to customer device 110 to confirm that acceptance of the customer disincentive has been received (e.g., a confirmation email). If the received additional information indicates that customer 112 has declined the customer disincentive, financial service provider device may note the refusal of the disincentive (e.g., store a message in a database), and/or process 300 may stop.

After steps 320-340 have been completed as necessary, customer 112 may have decided to accept and/or submit to the customer disincentive identified by financial service provider device 130. In some embodiments, financial service provider device 130 executes additional instructions to process the customer disincentive (step 350). For example, financial service provider device 130 may receive processing information from one or more of customer device 110 and merchant device 120. For example, customer 112 may use customer device 110 to capture information, such as a picture of a receipt, ticket, and transmit the information to financial service provider device 130. Financial service provider device 130 may receive disincentive instructions to temporarily freeze a financial account associated with customer 112 from customer device 110 and/or merchant device 130.

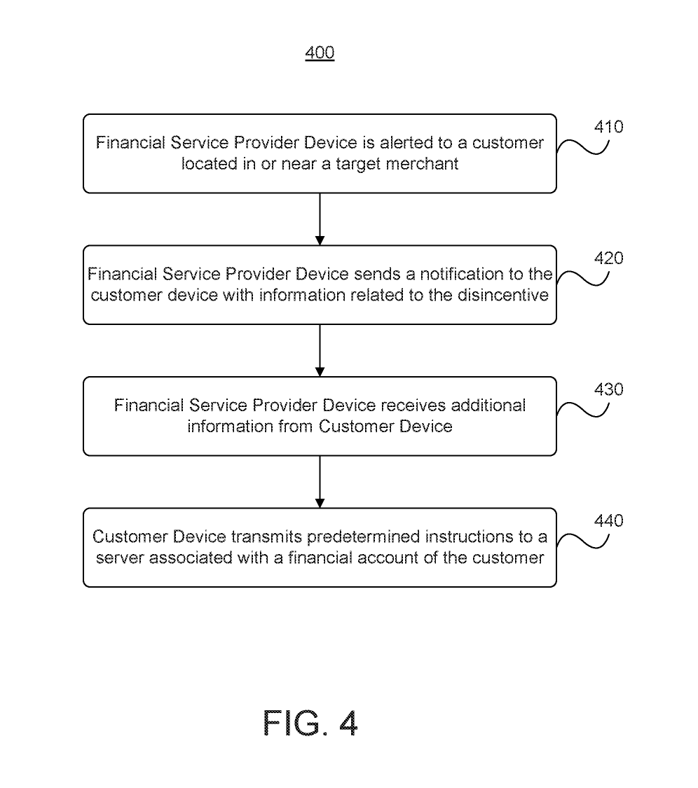

FIG. 4 is a flowchart of an exemplary process 400 performed by financial service provider device 130 for providing a customer disincentive before a transaction is made. In some aspects, process 400 may be performed to make a customer aware of a customer disincentive at a time when the customer disincentive may be useful. For example, process 400 may relate to notifying a customer that they are approaching (e.g., within a block or two blocks) a particular merchant's premises. The particular merchant may be stored in memory maintained by the financial service provider and accessible by financial service provider device 130, as entered by customer 112 on device 110 and received by financial service provider device 130 as part of the customer preference data. In other aspects, process 400 may be used to provide the customer disincentive, to prohibit the customer from making purchases they have previously identified as purchases they do not want to make. In describing process 400, the customer is assumed to be customer 112 associated with customer device 110.

Process 400 includes financial service provider device 130 being alerted that customer 112 is located in or near a target merchant (step 410). A target merchant may be a merchant (e.g., a merchant associated with merchant device 120) that is identified as being relevant to the customer disincentive option that may be subject to process 400. For example, if the customer disincentive option is to freeze a financial account of customer 112 while near a coffee shop or retail store. Several target merchants may be simultaneously used in relation to process 400.

Financial service provider device 130 may be alerted that customer 112 is at or near a target merchant through the use of known geo-fencing processes. The geo-fencing process may include determining whether the customer device 110 is located within a predetermined location boundary near the target merchant. In order to determine if customer device 110 is within the predetermined boundary, customer device 110 may determine its own location, which may be determined via GPS or other location-based measurements. In some aspects, customer device 110 may send the location information, such as latitude-longitude coordinates, to financial service provider device 130. Financial service provider device 130 may process the received information to determine if customer device 110 is within a particular predetermined boundary associated with any target merchants.

In other aspects, customer device 110 may determine that it is within a predetermined boundary of a target merchant and send only a notification (instead of location information) to financial service provider device 130 signaling a location near a target merchant. In some embodiments, customer 112 may use customer device 110 to “check-in” to a particular location, such as a particular merchant, indicating where they are currently located. According to some embodiments, the customer may “check-in” via a social networking website or application using customer device 110. Customer device 110 may transmit the “check-in” information to financial service provider device 130 such that the financial service provider is notified of the customer's current location. In other embodiments, the location of customer 112 is determined through the Foursquare™ application on customer device 110. Customer device 110 may transmit Foursquare™ application data to financial service provider device 130 such that the financial service provider is notified of the customer's current location. In other embodiments, customer device 110 may transmit data indicating proximity to a merchant's point of sale terminal.

After being notified that customer 112 is at or near a target merchant, financial service provider device 130 may send a notification that includes information related to the customer disincentive associated with the target merchant to customer device 110 (step 420). For example, when financial service provider device 130 becomes alerted to customer 112 being in or near a coffee shop, for example, the notification may include information related to the customer's shopping history at that particular coffee shop, or at coffee shops in general. The notification may be that the customer's credit line will be cut off until customer 112 leaves the coffee shop. It should be understood that financial service provider device 130 may perform additional processing to associate a particular customer device 110 with a particular customer disincentive option and a target merchant, as well as any necessary determinations of eligibility, agreement, disincentive parameters, etc.

In some embodiments, process 400 may end after customer 112 has been notified of the information sent from financial service provider device 130 to customer device 110, which may be displayed to customer 112 by customer device 110. In this way, process 400 may be used to make customer 112 aware of the customer disincentive that is available at a time when customer 112 may want that information.

In other embodiments, customer 112 may want more specific information regarding their spending at a target merchant, which may require additional communication between customer device 110 and financial service provider device 130. In these embodiments, financial service provider device 130 receives additional information from customer device 110 (step 430). The additional information may be related to a possible transaction at a target merchant. For example, customer device 110 may receive information about the spending history of the customer at a target merchant.

In other embodiments, when customer 112 approaches a target merchant, customer device 110 will receive a notification alerting customer 112 to the disincentive. If customer 112 enters the target merchant's premises, an instruction is transmitted to financial service provider device 130 to freeze a financial account associated with customer 112. The account may be frozen while customer 112 remains in the premises. The account may be unfrozen after a period of time, for example 30 minutes, or alternatively, upon exiting the merchant's premises. In other embodiments, the account may be frozen temporarily, for example 5, 10, 15, 20, 25, 30 minutes, or any predetermined amount of time.

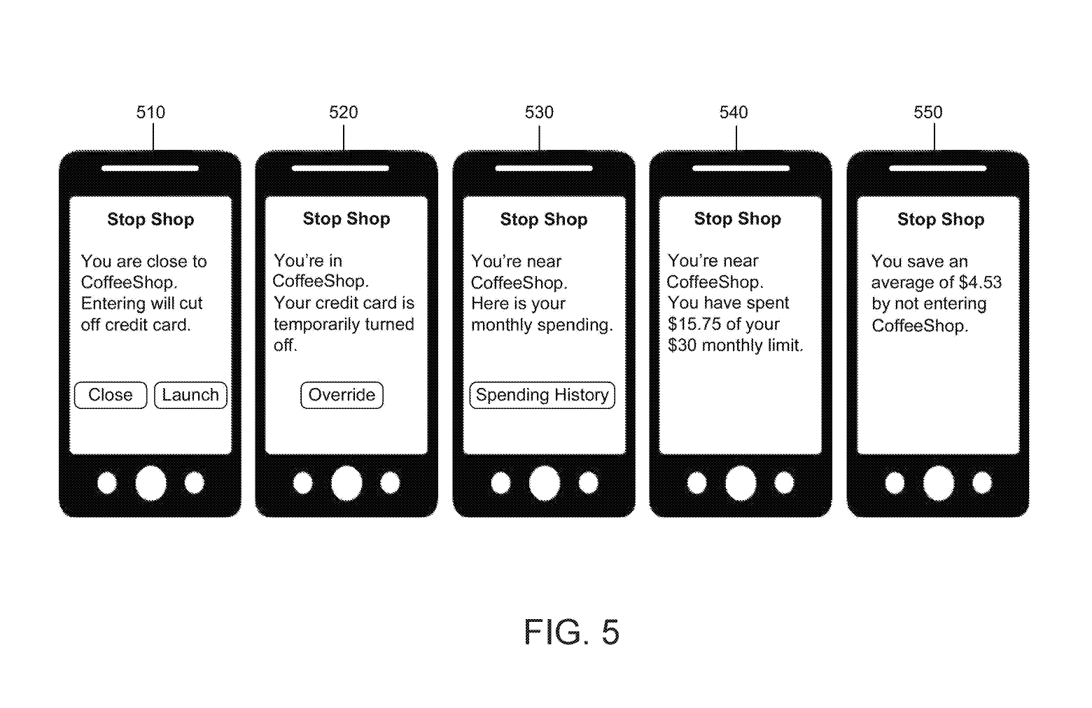

FIG. 5 includes exemplary depictions of user interfaces on customer device 110, depicting information e.g., to customer 112, consistent with disclosed embodiments, including information consistent with one or more of the disincentives discloses herein. Depiction 510 shows an exemplary customer alert consistent with disclosed embodiments. As shown, depiction 520 includes an exemplary message informing customer 112 that their credit card will be temporarily inactive while inside or near a target merchant. Depiction 520 includes an exemplary message that informs customer 112 of their customer disincentive override option. Depiction 530 includes an interactive menu and/or message prompts that allow customer 112 to control customer device 110 to work in conjunction with financial service provider device 130 to provide customer disincentive and/or spending history information. FIG. 540 shows an exemplary user interface alerting customer 112 to their preset monthly spending limit. Depiction 550 shows an exemplary user interface informing customer 112 of potential savings.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

1. A system for providing a customer disincentive, comprising:
one or more memory devices storing software instructions; and
one or more processors configured to execute the software instructions to:
receive customer data and customer location data from a device associated with a customer of the financial service provider through a wireless network;
identify the customer based on the customer data;
identify a merchant and merchant premises in proximity of the customer location based on the received location data;
identify a financial account associated with the customer;
determine an applicable customer disincentive option based on the identified merchant and customer preference data included in the received customer data and the financial account, the disincentive option relating to a potential retail transaction for goods or services with the identified merchant;
transmit through the wireless network a notification to the customer device before the customer initiates a transaction with the merchant, the notification including the determined disincentive option,
wherein the notification is configured to be dynamically displayed on the customer device according to selections made by the customer; and
freeze, before the customer initiates the transaction with the merchant, the financial account based on the determined disincentive option and the customer location data.

2. The system of claim 1, wherein the customer preference data identifies categories of merchants.

3. The system of claim 1, wherein the customer preference data identifies a specific merchant.

4. The system of claim 2, wherein the customer preference data includes an alert in the transmitted notification that the customer is at or near a merchant premises in the identified category of merchants.

5. The system of claim 3, wherein the customer preference data includes an alert in the transmitted notification that the customer is at or near the specific merchant premises.

6. The system of claim 4, wherein the alert in the transmitted notification includes a transaction history of the customer with the category of merchants.

7. The system of claim 5, wherein the alert in the transmitted notification includes a transaction history of the customer with the specific merchant.

8. (canceled)

9. (canceled)

10. The system of claim 1, wherein the transmitted notification includes an option to override the determined disincentive option.

11. The system of claim 1, wherein the freezing occurs while the customer remains on the merchant premises based on the received customer location data.

12. The system of claim 1, wherein the customer preference data includes a spending cutoff threshold associated with either a category of merchants or a specific merchant or both in the determined disincentive option.

13. The system of claim 12, wherein the transmitted notification includes an alert notifying the customer of their spending relative to the threshold.

14. The system of claim 13, wherein the customer preference data includes instructions to freeze the financial account of the customer when the threshold is exceeded

15. A method for a financial service provider to provide a customer disincentive, comprising:
receiving customer data and location data from a device associated with a customer of the financial service provider through a wireless network;
identifying a merchant and merchant premises in proximity of the customer location based on the received location data;
identifying a financial account associated with the customer;
determining, by one or more processors, an applicable customer disincentive option for the customer of the financial service provider based on the identified merchant and customer preference data included in the received customer data and the identified financial account, the disincentive option relating to a potential retail transaction for goods or services with the identified merchant;
transmitting through the wireless network a notification to the device associated with the customer of the financial service provider, the notification including the determined disincentive option, the notification being transmitted when the customer is in proximity of a merchant premises and before the customer initiates a transaction with the merchant,
wherein the notification is configured to be dynamically displayed on the customer device according to selections made by the customer; and
freezing, before the customer initiates the transaction with the merchant, the financial account based on the determined disincentive option and the customer location data.

16. (canceled)

17. The method of claim 15, wherein the freezing occurs while the customer remains on the merchant's premises based on the received data.

18. The method of claim 15, wherein the transmitted notification includes an option for the customer to override the determined disincentive option.

19. The method of claim 15, wherein the transmitted notification includes a transaction history with a category of merchants or a transaction history with a specific merchant.

20. The method of claim 15, wherein the transmitted notification includes an alert that the customer is at a merchant from an identified category determined from the received customer data.
